(19) United States
(12) Patent Application Publication
(10) Pub. No.: US 2025/0164828 A1
(43) Pub. Date: May 22, 2025

(54) DETACHABLE SIDE SHIELD STRUCTURE OF SPECTACLES

(71) Applicant: PROHERO GROUP CO., LTD., TAINAN CITY (TW)

(72) Inventor: PEN-WEI CHEN, TAINAN CITY (TW)

(21) Appl. No.: 18/510,807

(22) Filed: Nov. 16, 2023

(51) Int. Cl. G02C 11/00

(52) U.S. Cl. CPC G02C 11/12

(57) ABSTRACT

The present invention relates to a detachable side shield structure of spectacles, which mainly a side shield unit, arranged at the pivot joint between the temple and the frame, and includes a shielding portion for shielding, a blocking bar protruded from an outer edge, and a snap portion provided on an inner edge of a top surface of the shielding portion. The snap portion has a detachable embedded portion arranged on an inner side thereof, which can correspond to a catching portion at the pivot joint of the temple and engage with each other. The temple is limited through the blocking bar and the snap portion, and the detachable embedded portion of the snap portion and the catching portion on the pivot joint form a detachable latch positioning structure, so that the side shield unit can be firmly coupled to the temple and can be disassembled and assembled as needed.

### BACKGROUND OF THE PRESENT INVENTION

### Field of Invention

The present invention relates to a technical field involving shielding the side space of the temples, and in particular, to a detachable side shield structure of spectacles as the primary invention application.

### Description of Related Arts

In order to prevent foreign objects and strong light from entering the eyes from the sides and causing eye damage, glasses or sunglasses that are common in daily life are also equipped with side shields on both sides of the glasses frame as a protective measure.

In addition to the above-mentioned sunshade function, when people are engaged in some work or high-speed activities, in order to prevent their eyes from being assaulted by strong winds or being injured by collisions with foreign objects, they are generally accustomed to wearing various types of goggles. The covering parts formed by extending from both sides of the glasses frame of these types of goggles are used to cover and fit around the user's eyes to prevent strong wind and foreign objects from contacting the eyes, thereby achieving the effect of protecting the eyes. However, the covering parts of these types of goggles on both sides of the glasses frame are integrally formed by being extended from both sides of the glasses frame, which does not allow users to choose and match according to their own preferences and also takes up a lot of storage space.

In addition, there is a type of side shield that is mainly assembled on the outside of the temple using screws or hooks. Although it solves the problem of the integral forming mentioned above, if the screw fastening point of the side shield is frequently disassembled, the screw hole may wear out and cannot securely combine. Therefore, most of the attached side shields have gaps between them and the temple, making them prone to detachment and still having many drawbacks and inconveniences.

In view of this, with the spirit of continuous improvement and based on years of rich design, development, and practical production experience in the related industry, the inventor provides a detachable side shield structure of spectacles, aiming to achieve better practical value.

### SUMMARY OF THE PRESENT INVENTION

The main purpose of the present invention is to provide a detachable side shield structure of spectacles, in particular a design that allows shielding objects to be installed on the sides of the temples, which are encased on the temples using detachable technology for the purpose of stable assembly.

The main purpose and effect of the detachable side shield structure of spectacles of the present invention are achieved by the following specific technical means:
a side shield unit, arranged at the pivot joint between the temple and the frame, and includes a shielding portion for shielding, a blocking bar protruded from an outer edge of a top surface of the shielding portion, and a snap portion provided on an inner edge of the top surface, wherein the snap portion has a detachable embedded portion arranged on an inner side thereof, which can correspond to a catching portion at the pivot joint of the temple and engage with each other. In this way, the temple is limited through the blocking bar and the snap portion, and the detachable embedded portion of the snap portion and the catching portion on the pivot joint form a detachable latch positioning structure, so that the side shield unit can be firmly coupled to the temple and can be disassembled and assembled as needed, achieving the advantages and effects of convenient disassembly and assembly and stability.

According to a preferred embodiment of the detachable side shield structure of spectacles of the present invention, a space for accommodating the temple is further formed between the blocking bar and the snap portion.

A preferred embodiment of the detachable side shield structure of spectacles of the present invention, the blocking bars are respectively protruded from the outer edge of the top surface of the shielding portion corresponding to the two sides of the snap portion.

### BRIEF DESCRIPTION OF THE DRAWINGS

FIG. 1 is an exploded view according to the present invention.

FIG. 2 is an assembled perspective view of the side shield unit of the present invention installed on the temple.

FIG. 3 is an assembled sectional view of the side shield unit of the present invention installed on the temple.

FIG. 4 is a perspective view of the side shield unit of the present invention stuck at the pivot joint of the temple.

FIG. 5 is a sectional view of the side shield unit of the present invention stuck at the pivot joint of the temple.

FIG. 6 is a sectional view of the side shield unit of the present invention disassembled from the pivot point of the temple.

### DETAILED DESCRIPTION OF THE PREFERRED EMBODIMENT

In order to have a more complete and clear disclosure of the technical content, the purpose of creation and the effect achieved by the present invention, it is explained in detail below, and refer to the disclosed drawings and drawing numbers together.

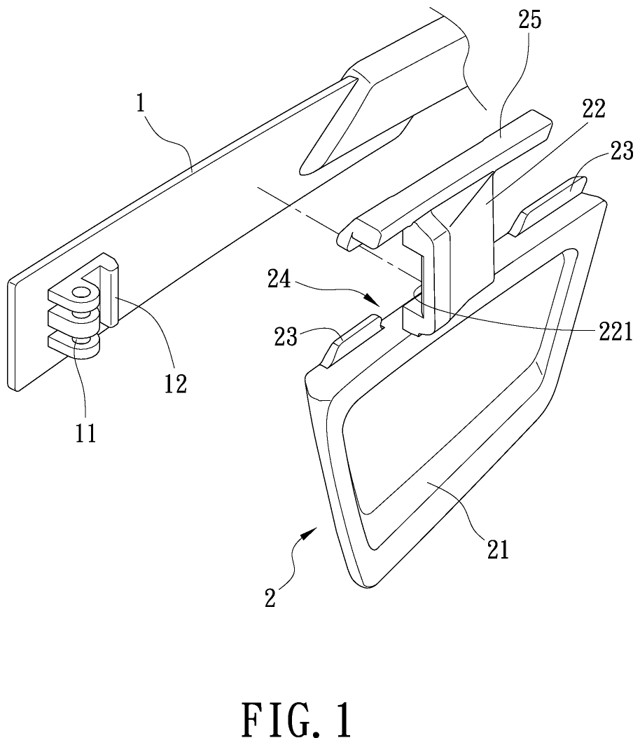

First, referring to FIGS. 1-4, which are exploded perspective views of the detachable side shield structure of spectacles of the present invention, which mainly include a temple (1) having a pivot joint (11) arranged corresponding with the frame and a catching portion (12) arranged at the pivot joint (11), and a side shield unit (2) arranged on the temple (1), wherein the side shield unit (2) corresponds with the catching portion (12) forms a detachable latch positioning structure, wherein
the side shield unit (2) includes a shielding portion (21) for shielding, a snap portion (22) provided on an inner edge of a top surface of the shielding portion (21), at least one blocking bar (23) protruded from an outer edge of the top surface, a space (24) for accommodating the temple (1) formed between the blocking bar (23) and the snap portion (22), and a locking cover portion (25) covering a top edge of the temple (1) provided above the snap portion (22), wherein the snap portion (22) has a detachable embedded portion (221) arranged on one side corresponding with the catching portion (12).

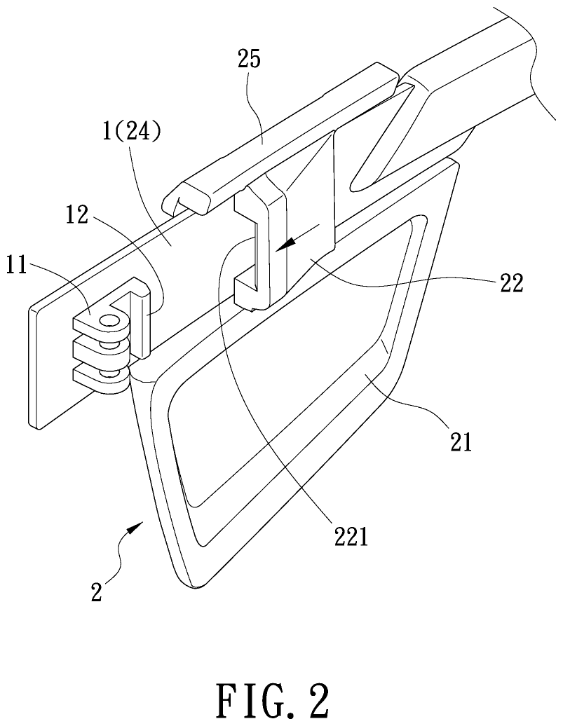

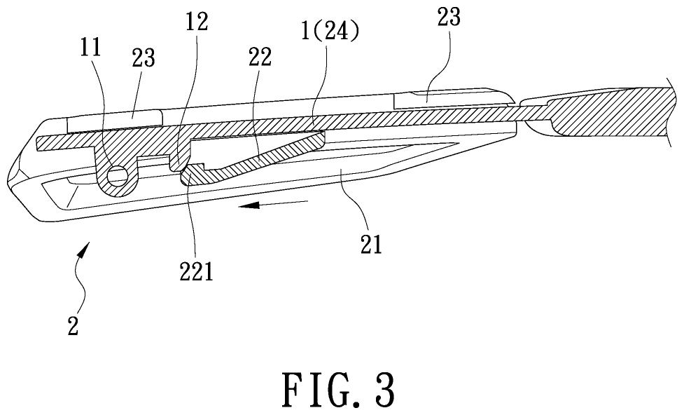

Referring to FIG. 1-6. In actual implementation, the side shield unit (2) is installed correspondingly from the inner side of the temple (1), the temple (1) is placed in the space (24) formed between the blocking bar (23) and the snap portion (22), the locking cover portion (25) covers the top edge of the temple (1), and the temple (1) is limited by the blocking bar (23) and the locking cover portion (25) [as shown in FIGS. 2-3]. Furthermore, the outer edge of the top surface of the shielding portion (21) is respectively provided with the blocking bars (23) corresponding to the two sides of the snap portion (22), so that the side shield unit (2) can be smoothly sliding-displaced on the temple (1) through the position limitation of the two blocking bars (23) relative to the snap portion (22).

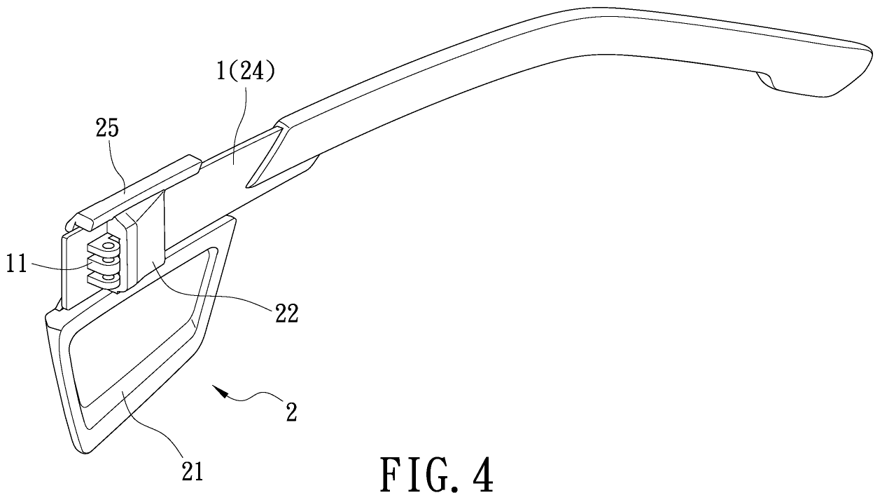

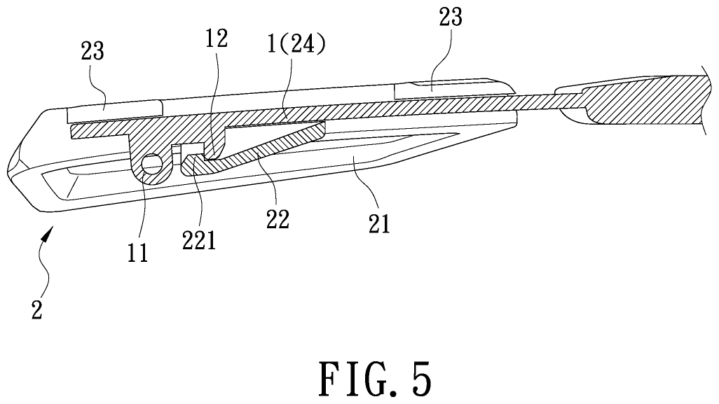

Then, the side shield unit (2) is pushed in the direction of the frame so that the detachable embedded portion (221) of the snap portion (22) can be positioned correspondingly to the catching portion (12) on the pivot joint (11), to firmly lock the side shield unit (2) at the pivot joint (11) of the frame and the temple (1) [as shown in FIGS. 4-5]. When the user wears spectacles, the side shield unit (2) can effectively cover the space on the side of the eye to prevent foreign objects, sunlight, etc.

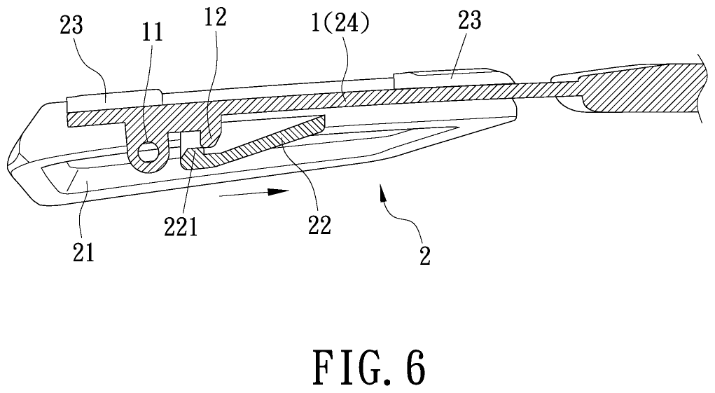

Further referring to FIG. 6, when the side shield unit (2) is not used, only the side shield unit (2) is pushed back, so that the detachable embedded portion (221) of the snap portion (22) is detached from the catching portion (12) on the pivot joint (11), and then the side shield unit (2) is disassembled. However, the structure of the detachable embedded portion (221) is designed according to the type of the catching portion (12), but it is not limited to any specific form. As long as the two devices are capable of being firmly engaged and detachable, it does not deviate from the patent scope of the present invention.

From the above description of the composition and use of the present invention, it can be seen that compared with the conventional structure, the present invention has the following advantages:

1. The detachable side shield structure of spectacles of the present invention limits the temple through the space formed between the blocking bar and the snap portion. Moreover, the detachable embedded portion of the snap portion and the catching portion on the pivot joint are firmly engaged and positioned, so that the side shield unit can be firmly combined with the temple, achieving the advantages and effects of stable installation.

2. The detachable side shield structure of spectacles according to the present invention, a side shield unit for shielding an object can be installed through the side of the temple. The side shield unit utilizes the detachable embedded portion of the snap portion and the catching portion on the pivot joint for detachable latch positioning on the temple and can be disassembled and assembled according to needs, achieving the advantages and effects of convenient disassembly and assembly.

What is claimed is:

1. A detachable side shield structure of spectacles, which mainly comprises a temple having a pivot joint arranged corresponding with the frame and a catching portion arranged at the pivot joint, and a side shield unit arranged on the temple, wherein the side shield unit corresponds with the catching portion forms a detachable latch positioning structure, wherein
the side shield unit comprises a shielding portion for shielding, a snap portion provided on an inner edge of a top surface of the shielding portion, at least one blocking bar protruded from an outer edge of the top surface, a space for accommodating the temple formed between the blocking bar and the snap portion, and a locking cover portion covering a top edge of the temple provided above the snap portion, wherein the snap portion has a detachable embedded portion arranged on one side corresponding with the catching portion.

2. The spectacle temple side shield structure as claimed in claim 1, wherein the blocking bars are respectively protruded from the outer edge of the top surface of the shielding portion corresponding to the two sides of the snap portion.
